(19) United States
(12) Patent Application Publication
(10) Pub. No.: US 2012/0107662 A1
(43) Pub. Date: May 3, 2012

(54) THERMAL MANAGEMENT MATRIX

(76) Inventors: Mike Römmler, Los Angeles, CA (US); Brian Ford, Grayslake, IL (US); Steve Wendel, St. Marys, PA (US); Tim Krull, Kersey, PA (US)

(21) Appl. No.: 12/915,340

(22) Filed: Oct. 29, 2010

(51) Int. Cl. H01M 10/50; B21D 53/02

(52) U.S. Cl. 429/120; 29/890.03

(57) ABSTRACT

A thermal management matrix for an electrochemical cell array including a plurality of electrochemical cell elements, the thermal management matrix at least in part enveloping the electrochemical cell array and being in thermal contact therewith. The thermal management matrix includes mainly expanded graphite, wherein the expanded graphite is arranged in the form of a block-like structure and the block includes at least one layer of expanded graphite having a higher in-plane thermal conductivity than the layers neighboring the layer with higher in-plane thermal conductivity. The thermal management matrix may also include phase change materials as a latent heat storage material.

### BACKGROUND OF THE INVENTION

1. Field of the Invention

The present invention relates to a thermal management matrix for an electrochemical cell array including a plurality of electrochemical cell elements, the matrix including layers of expanded graphite with different densities in the form of a sandwich-like structure.

2. Description of the Related Art

The need for thermal management systems to improve Li-ion battery performance, extend battery life and reduce the risks of thermal runaway are well known. Different systems have been developed to address these problems. One present technology differs from the others in that they use PCM (Phase Change Material) infiltrated graphite as a passive solution, to dissipate heat from individual cells in multi-cell modules. This solution is particularly effective where thermal problems are intermittent or “transient”. Other active systems developed for comparison use fluid circulating in metal jackets to dissipate heat and effectively control steady-state thermal conditions. Another advantage of active systems is that they can heat as well as cool the modules, which is important in areas with extreme seasonal temperature changes.

As mentioned above, a PCM/graphite system offers the advantage of a passive system, with no moving parts (pumps, temperature sensors, seals, controls, etc.) to fail. They are simple and relatively inexpensive. The thermal anisotropy inherent in the molded graphite blocks manufactured using expanded graphite worms effectively transfers heat from the Li-ion cells towards the perimeter of the modules where it can be dissipated. A disadvantage of the system is that once the PCM/graphite becomes “saturated” with heat, it retains it for a long period of time. PCM is the primary weight component of the “compound” and, if paraffin based, is flammable.

Metal systems (machined, formed, extruded) can be complex, heavy, expensive and require many more components (fittings, fixtures, thermal interface materials, etc.) to be effective. Differences in CTE (Coefficient of Thermal Expansion) between the metal (aluminum) and the cells, presents additional engineering challenges. These systems typically have their own fluid circulation systems, further increasing space and weight.

EP 1 972 675 A2 and U.S. Pat. No. 7,235,301 B2 disclose latent heat storage material comprising at least one phase change material and expanded graphite. No sandwich structure of the thermal management matrix is disclosed herein.

### SUMMARY OF THE INVENTION

What is needed in the art is an enhanced thermal management system to improve Li-ion battery performance, extend battery life and reduce the risks of a thermal runaway, thereby overcoming the disadvantages of the state of the art.

The present invention provides a thermal management matrix for an electrochemical cell array. More specifically the present invention provides a thermal management matrix for an electrochemical cell array including a plurality of electrochemical cell elements, the thermal management matrix at least in part enveloping the electrochemical cell array and in thermal contact therewith. The thermal management matrix according to the present invention includes mainly expanded graphite, arranged in the form of a block-like structure. The block includes at least one layer of expanded graphite having a higher in-plane thermal conductivity than the in-plane thermal conductivity of the layers neighboring the layer with the higher in-plane thermal conductivity.

According to one embodiment of the present invention, at least two layers of expanded graphite with higher thermal conductivity may be present and/or the layers may be parallel to each other.

According to a second embodiment of the present invention, the at least one layer of expanded graphite with higher thermal conductivity may be present in the form of a foil.

According to a third embodiment of the present invention, the at least one layer of expanded graphite with higher thermal conductivity may be arranged either parallel to the longitudinal direction of the electrochemical cell elements or orthogonal to the longitudinal direction of the electrochemical cell elements.

According to a fourth embodiment of the present invention, the at least one layer with higher in-plane thermal conductivity may have an in-plane thermal conductivity in the range of approximately 100 to 600 W/mK and the in-plane thermal conductivity of the other layers have an in-plane thermal conductivity in the range of approximately 4 to 50 W/mK.

According to a fifth embodiment of the present invention, the at least one layer of expanded graphite with higher in-plane thermal conductivity has a higher density than the layers with the lower in-plane thermal conductivity. In that context, the at least one layer with higher density has a density, for example, in the range of approximately 0.5 to 2.0 g/cm³ and the density of the other layers have, for example, a density in the range of approximately 0.05 to 0.5 g/cm³.

According to the present invention the thermal conductivity of the layers of the block may be higher either in the orthogonal or the parallel direction.

The parts of the thermal management matrix enveloping the electrochemical cell array, and in thermal contact therewith, may further be coated with one or more phase change materials(s). According to the present invention at least the expanded graphite neighboring the layer with higher in-plane thermal conductivity may be infiltrated with phase change materials.

Further, the at least one layer of expanded graphite with higher in-plane thermal conductivity may be arranged orthogonal to the longitudinal direction of the electrochemical cell elements, and the at least one layer neighboring the layer with the higher in-plane thermal conductivity formed out of two modules may have multiple circular grooves equal to half the diameter of the electrochemical cell elements. The two modules in an assembled form then may envelope the electrochemical cell array.

The present invention further provides a process for producing a thermal management matrix from expanded graphite. A first embodiment of the process for producing a thermal management matrix from expanded graphite, according to the present invention, includes the following steps:

a) producing a planar pre-formed piece from expanded graphite having an in-plane thermal conductivity in the range of approximately 4 to 50 W/mK;

b) placing a layer of a foil of compressed expanded graphite having an in-plane thermal conductivity in the range of approximately 100 to 600 W/mK on top of the produced planar pre-formed piece of step a);

c) repeating steps a) and b) and finally a), until the desired thickness of the block is formed; and

d) boring out holes adapted in size to envelope the electrochemical cell elements.

The expanded graphite used in step a) may be infiltrated with one or more phase change material(s) prior to use in step a). Further, in the context of the process according to the present invention, the finally formed block may be coated with one or more phase change material(s). The formed borings may further be coated with one or more phase change material(s).

The desired thickness of the block formed may be higher than the electrochemical cell elements to be enveloped and the process include the further steps performed after step d):

e) inserting the electrochemical cell elements into the hole provided in step d); and

f) compressing the block of pre-formed expanded graphite together with the inserted electrochemical cell elements to form an intimate contact of the expanded graphite material with the outer surface of the electro-chemical cell elements.

The present invention further provides a second embodiment of a process for producing a thermal management matrix from expanded graphite which includes the following steps:

a) providing a layer of a foil of compressed expanded graphite having an in-plane thermal conductivity in the range of approximately 100 to 600 W/mK;

b) producing two pre-formed pieces from expanded graphite having an in-plane thermal conductivity in the range of approximately 4 to 50 W/mK, the pre-formed pieces including semi-circular grooves equal to approximately one-half the diameter of the electrochemical cell element;

c) placing together the two pre-formed pieces obtained in step a) in such a manner that cylindrical envelopes are formed out of the semi-circular grooves;

d) placing the assembly of step c) with one planar side on top of the layer provided in step a);

e) placing a layer of a foil of compressed expanded graphite having an in-plane thermal conductivity in the range of approximately 100 to 600 W/mK on top of the other planar side of the assembly obtained in step c); and

f) repeating steps b), c) and e) until the desired thick-ness of the block is formed.

The expanded graphite used in step b) may be infiltrated with the phase change materials prior to use in step b). Additionally, the finally formed block may be coated with the phase change materials. Further, the formed cylindrical envelopes may be coated with phase change materials.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a thermal management matrix for an electrochemical cell in accordance with a first embodiment of the present invention;

FIG. 2 is a partly exploded perspective view of a thermal management matrix for an electrochemical cell shown in FIG. 1;

FIG. 3 is a perspective view of a thermal management matrix for an electrochemical cell in accordance with a second embodiment of the present invention;

FIG. 4 is a partly exploded perspective view of a thermal management matrix for an electrochemical cell shown in FIG. 3; and

FIG. 5 is a perspective view of a module as present in FIG. 4, as part of the second embodiment of the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

Modular cylindrical cell battery systems typically consist of multiple rows of cylindrical cells. To increase power, the systems just multiply the number of rows to meet different power requirements. As the modules are combined, air cooling becomes less effective and liquid cooling is required. In the art it has been attempted to convert the original machined aluminum design to an extruded aluminum version to reduce cost, but it is difficult to maintain desired tolerances and the interface issue remains. Graphite is a potentially attractive option because it is non-flammable, light weight and has good thermal conductivity. Thermal conductivity is also anisotropic, helping to move heat from the core to liquid cooled cold-plates which are attached to the sides of the modules. PCM/graphite, as stated above, may be less desirable when the thermal load is steady-state, not transient.

The present invention uses expanded graphite to form layers that are stacked on each other in order to form a block-like system or structure that can be of any suitable size to embed an electrochemical cell. The layers used include at least two different in-plane thermal conductivity properties. One of the layers has a higher in-plane thermal conductivity than the layers neighboring the layer with the higher in-plane thermal conductivity. These layers are, for example, in the form of a foil made from expanded graphite. This foil includes a higher in-plane thermal conductivity and acts like a highway for dissipating heat from the electrochemical cells to cooling plates that are, for example, arranged at the outer surfaces of the block-like structure. In this way, an effective cooling and an advantageous thermal management within the matrix is achieved. By arranging the layers in accordance with the present invention, the thermal management matrix shows superior properties over the systems known in the art.

To carry out the present invention, expanded graphite is used in the form of a foil having a thermal conductivity in the range of approximately 100 to 600 W/mK in-plane and in the range of approximately 2 to 50 W/mK through-plane and a density of the foil is in the range of approximately 0.5 to 2.0 g/cm³. Further, expanded graphite is used in the form of a pre-compact having a thermal conductivity in the range of approximately 4 to 50 W/mK in-plane and in the range of approximately 2 to 8 W/mK through-plane and the density of the foil is in the range of approximately 0.05 to 0.5 g/cm³. But it will be apparent to a skilled artesian that expanded graphite may be also used that deviates from the given ranges and may lead to an embodiment of the present invention that is within the scope of the claims and the present description.

The present invention may be embodied in a variety of different structures.

Referring now to FIG. 1, there is shown a first embodiment of the present invention wherein multiple layers of pre-compact expanded graphite are laminated with sheets of graphite foil between them. More specifically, FIG. 1 shows first thermal management matrix 1, including multiple layers 2, 3, that are arranged in a sandwich form. Layers 2 and 3 are formed out of expanded graphite. Layers 2 and 3 have different in-plane thermal conductivities, whereas the in-plane thermal conductivity of layer 3 is higher than the in-plane thermal conductivity of layer 2. The arrangement of the matrix in the form of a sandwich structure shows layer 2 with a lower in-plane thermal conductivity on the top and on the bottom end of the block-like structure. Layers 3 are inserted in between layers 2, neighboring layers 3 with higher in-plane thermal conductivity. The matrix block is provided with openings 4, having a cylindrical size in order to envelope the electrochemical cell elements that may be inserted therein.

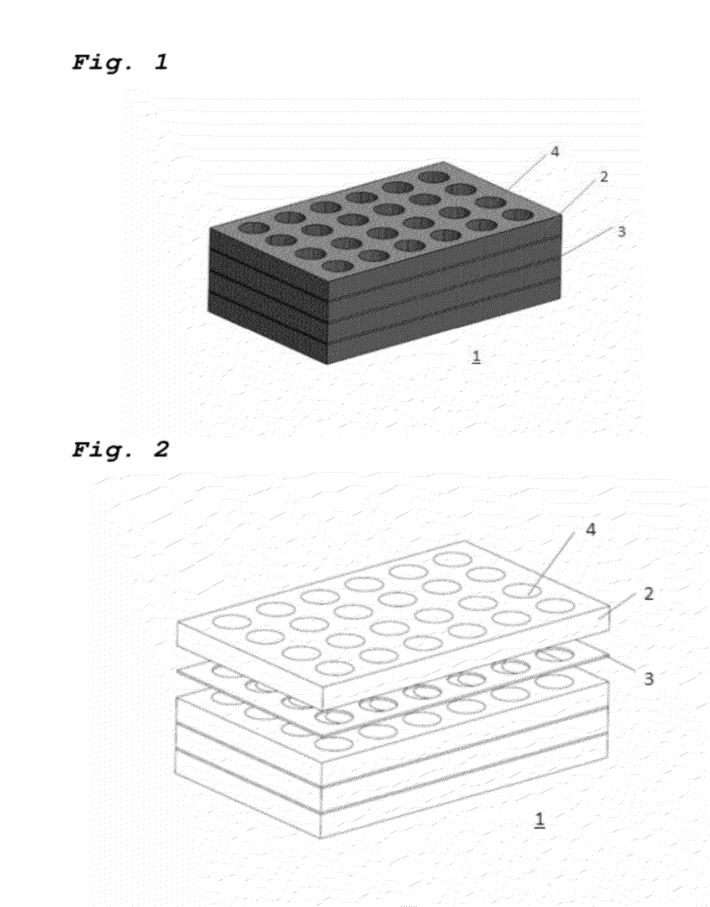

Referring now to FIG. 2, there is shown a partly exploded view of FIG. 1 in greater detail. While both materials are anisotropic, the higher conductivity of the foil enhances heat transfer from the cells to the perimeter cold-plate. The foil can also be increased in areas of high heat flux and reduced in low heat flux areas to increase/decrease heat transfer and “tune” the solution. The foil also increases the rigidity of the laminated “block”. Adhesives can be either conductive or nonconductive to increase/decrease anisotropy and heat transfer, or to disrupt eddy currents generated by the cells. Plastic or metal foils could also be laminated to the graphite foil or placed between the graphite pre-compact for similar reasons.

The blocks can be made to whatever thickness is desired, simply by adding more layers. Holes for the cells are then cut out of the block to suit the cell pattern of the module. The blocks can be made thicker than the desired finished thickness of the module and compressed to finished size during assembly. This compression step increases the density and thermal conductivity of the block, and also forces intimate contact between the graphite and the cells, eliminating the need for thermal interface materials and further simplifying assembly. Expanded graphite is able to compress and recover, to maintain contact with the cells due to expansion and contraction during thermal cycling.

According to the present needs in certain environments the matrix may be treated with phase change materials (PCM). If, for example, full infiltration of PCM throughout the block is not required, a light dip may be necessary to limit free graphite particles. As an alternative, an external coating (lacquer, rubber, silicone, etc.) could limit free particles and encapsulate the “block”.

For applications that require full PCM infiltration, the pre-compact/foil blocks with holes cut in them, will accept the PCM faster and minimize the amount of PCM required. In the art it is described to mold a block from graphite worms, infiltrate the whole block with PCM, then machine out the cell holes wasting graphite and PCM. By contrast, the present invention uses foil sheets between the layers of pre-compact and bores out the cell holes prior to PCM infiltration. The graphite “holes” can be recycled for other applications. Area weight uniformity and hence density and thermal conductivity, are easier to control according to the method of the present invention.

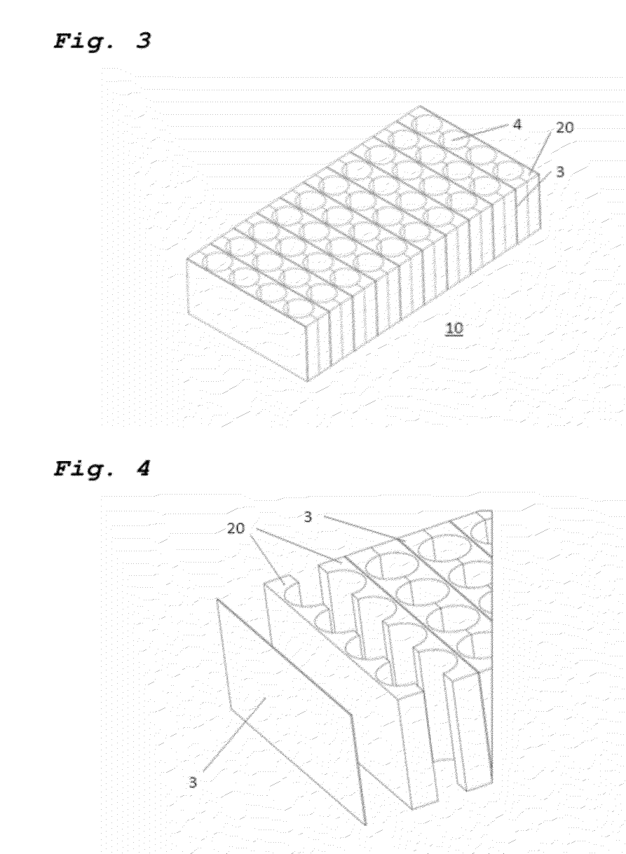

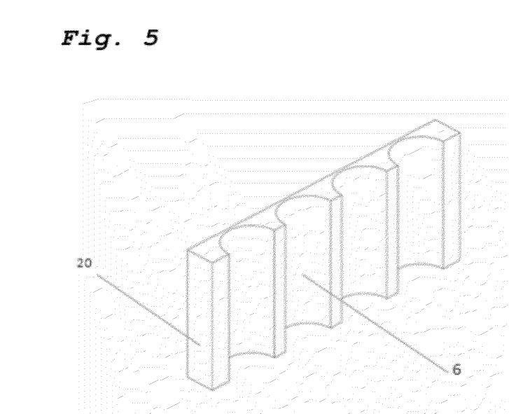

According to a second embodiment of the present invention, molded pieces of pre-compact are used to create a modular design. FIGS. 3 to 5 show different perspective views of this embodiment. Thermal management matrix 10 according to this embodiment of the present invention includes modules 20 and layers 3 with higher density arranged between modules 20. Two modules 20 are arranged facing their grooved side to each other and leaving plane surfaces on the other ends. On these plane surfaces layers 3 in the form of foils are attached. As shown particularly in FIG. 5, grooves 6 are of a semi-cylindrical form and when faced to each other form a cylindrical envelope for electrochemical cell elements.

In other words, in this embodiment of the present invention, multiple semi-circular grooves 6 equal to approximately one-half the diameter of the Li-ion cells in the stack, are molded into sheets of pre-compact to form one-half of module 20. Thickness can be adjusted by the number of pre-compact layers 20, 3 used and shape can easily be changed to accommodate the shape of the cell (cylindrical, prismatic, etc.). According to this embodiment of the present invention, two half modules 20 would be assembled to surround and support the Li-ion cells. Graphite foil 3 is positioned between pre-compact modules 20 to convey heat laterally and vertically, increasing heat transfer from the core and cooling the interior cells in a stack. The molded graphite modules are then banded together or constrained through other means, in the stack assembly process. This embodiment of the present invention provides all the advantages of modularity, such as scalability, cost reduction from damage/scrap through reduction of the size of individual pieces, lower tooling costs, etc. and simplifies the manufacturing process. For all of these reasons, this embodiment of the present invention is a very attractive solution of the problem as given above.

As already indicated, it is important to use suitable expanded graphite in order to carry out the invention. Exemplary expanded graphite includes Ecophit® L, supplied by SGL Group, Germany. The expanded graphite has an in-plane thermal conductivity between approximately 6.5 and approximately 25 W/mK and a density between approximately 0.05 and 0.2 g/cm³ and is easily further compressible. Expanded graphite with higher density in the form of a foil that can be used according to the present invention includes Sigraflex® foil, supplied also by SGL Group. The named foil has an in-plane thermal conductivity between approximately 180 and 200 W/mK and a density range from 0.7 to 1.3 g/cm³.

The process for the production of moldings of expanded graphite is known in the art. U.S. Pat. No. 7,520,953 B2 describes a suitable process and is herewith incorporated by reference.

Suitable phase change materials are also known in the art. EP 1 972 675 A2 and US 2009/0004556 A1 disclose suitable PCM useful in the context and the sense of the present invention and are incorporated herein by reference.

The thermal management matrix according to the present invention has the advantage of being easily adaptable to a great variety of electrochemical cell elements. The matrix shows anisotropic heat dissipation and is easy to produce.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A thermal management matrix for an electrochemical cell array including a plurality of cell elements, the thermal management matrix comprising:
expanded graphite arranged in a block-like structure, the thermal management system formed substantially of said expanded graphite and said block-like structure including at least one layer of said expanded graphite having a first in-plane thermal conductivity higher than a second in-plane thermal conductivity of a plurality of other layers of expanded graphite neighboring said at least one layer, wherein the thermal management matrix envelopes the electrochemical cell array at least in part and is in thermal contact with the electrochemical cell array.

2. The thermal management matrix according to claim 1, wherein said at least one layer of said expanded graphite having said first higher in-plane thermal conductivity is at least two layers of expanded graphite, said at least two layers of expanded graphite being at least one of present and parallel to each other.

3. The thermal management matrix according to claim 1, wherein said at least one layer of expanded graphite is in the form of a foil.

4. The thermal management matrix according to claim 1, wherein said at least one layer of expanded graphite is arranged one of parallel to a longitudinal direction of the plurality of electrochemical cell elements and orthogonal to said longitudinal direction of the plurality of electrochemical cell elements.

5. The thermal management matrix according to claim 1, wherein said first in-plane thermal conductivity of said at least one layer of expanded graphite is in a range of approximately 100 to 600 W/mK and said second in-plane thermal conductivity of said plurality of other layers of expanded graphite is in a range of approximately 4 and 50 W/mK.

6. The thermal management matrix according to claim 1, wherein said at least one layer of expanded graphite has a first density higher than a second density of said plurality of other layers of expanded graphite.

7. The thermal management matrix according to claim 6, wherein said first density of said at least one layer of expanded graphite is in a range of approximately 0.5 to 2.0 g/cm³ and said second density of said plurality of other layers is in a range of approximately 0.05 to 0.5 g/cm³.

8. The thermal management matrix according to claim 1, wherein a third thermal conductivity of all of said at least one layer and said plurality of other layers is higher in one of said orthogonal direction and said parallel direction.

9. The thermal management matrix according to claim 1, wherein each of a plurality of parts of the thermal management matrix enveloping the electrochemical cell array and in thermal contact with the electrochemical cell array is coated with a plurality of phase change materials.

10. The thermal management matrix according to claim 1, wherein at least one neighboring layer of said plurality of other layers is infiltrated with said phase change material.

11. The thermal management matrix according to claim 1, wherein said at least one layer of expanded graphite is arranged orthogonal to said longitudinal direction of the electrochemical cell elements and said at least one neighboring layer is formed of two modules having a plurality of circular grooves equal to approximately one-half of a diameter of the electrochemical cell elements, said two modules being assembled to envelop the electrochemical cell array.

12. A process for producing a thermal management matrix from an expanded graphite, the process comprising the steps of:
a) producing a planar pre-formed piece from the expanded graphite, said planar preformed piece having an in-plane thermal conductivity in a range of approximately 4 to 50 W/mK;
b) placing a layer of a foil of a compressed expanded graphite on top of said planar pre-formed piece of said producing step a), said layer of foil of said compressed expanded graphite having a second in-plane thermal conductivity in a range of approximately 100 to 600 W/mK;
c) repeating said producing step a) and said placing step b) and finally said producing step a) to form a block of a desired thickness; and
d) boring out a plurality of holes adapted in size to envelope a plurality of electrochemical cell elements.

13. The process according to claim 12, further comprising the step of infiltrating said expanded graphite used in step a) with a plurality of phase change materials prior to producing said planar pre-formed piece in said step a).

14. The process according to claim 12, wherein said block is coated with said phase change materials.

15. The process according to claim 12, wherein said borings of said step d) are coated with said plurality of phase change materials.

16. The process according to claim 12, wherein a thickness of said block is higher than a thickness of said electrochemical cell elements enveloped by said block, the process further comprising the steps of:
e) inserting said electrochemical cell elements into said holes of said boring step d) after said boring step d); and
f) compressing said block together with said electrochemical cell elements to form an intimate contact of said expanded graphite material with an outer surface of said electrochemical cell elements.

17. A process for producing a thermal management matrix from expanded graphite, the process comprising the steps of:
a) providing a layer of a foil of a compressed expanded graphite having an in-plane thermal conductivity in a range of approximately 100 to 600 W/mK
b) producing two pre-formed pieces from the expanded graphite having an in-plane thermal conductivity in a range of approximately 4 to 50 W/mK, said preformed pieces including a plurality of semi-circular grooves equal to one-half of a diameter of an electrochemical cell element;
c) placing together said two pre-formed pieces of step a) to form an assembly of a plurality of cylindrical envelopes with said semi-circular grooves;
d) placing said assembly of said step c) with a planar side on top of said layer of said foil of said step a);
e) providing a second layer of foil of said compressed expanded graphite and placing said second layer of foil on top of an opposite planar side of said assembly formed in step c); and
f) repeating said steps b), c) and e) until a block of a desired thickness is formed.

18. The process according to claim 17, wherein said expanded graphite of said step b) is infiltrated with a plurality of phase change materials prior to producing said two pre-formed pieces in said step b).

19. The process according to claim 17, wherein said block formed in said step f) is coated with said plurality of phase change materials.

20. The process according to claim 17, wherein said cylindrical envelopes of step c) are coated with said plurality of phase change materials.
